(19) United States
(12) Patent Application Publication
(10) Pub. No.: US 2014/0331124 A1
(43) Pub. Date: Nov. 6, 2014

(54) METHOD FOR MAINTAINING COMMON DATA ACROSS MULTIPLE PLATFORMS

(71) Applicants: Locu, Inc., San Francisco, CA (US); Go Daddy Operating Company, LLC, Scottsdale, AZ (US)

(72) Inventors: Peter Downs, San Francisco, CA (US); Keir Mierle, San Francisco, CA (US); Rajatish Mukherjee, Sunnyvale, CA (US); Rajinder Nijjer, Phoenix, AZ (US); Marek Olszewski, San Francisco, CA (US); Justin Tsai, San Francisco, CA (US)

(21) Appl. No.: 14/108,044

(22) Filed: Dec. 16, 2013

Related U.S. Application Data
(63) Continuation-in-part of application No. 13/944,790, filed on Jul. 17, 2013.
(60) Provisional application No. 61/818,736, filed on May 2, 2013.

(51) Int. Cl. G06F 17/21

(52) U.S. Cl. CPC G06F 17/212
USPC 715/243

(57) ABSTRACT

Systems and methods are described for maintaining a user's common data across multiple platforms. The common data is information about the user and graphical and design elements of publications that should be consistently presented across online, other electronic, and non-electronic platforms, such as websites, social networking profiles, electronic and printed business listings, email and print newsletters, business cards, letterhead, and the like. The common data may be stored and updated by a centralized or distributed system including one or more servers communicating with the platforms and with a content database that retains the common data in a stored data structure. The system may provide an interface to the user, receive common data elements input by the user, add the common data elements to the stored data structure, and distribute the common data elements to the platforms. The system may identify which platforms require which elements of the common data.

### CROSS-REFERENCE TO RELATED APPLICATIONS

This application is a continuation-in-part and claims the benefit of U.S. patent application Ser. No. 13/944,790, filed Jul. 17, 2013, and incorporated herein by reference, and this application is a non-provisional and claims the benefit of U.S. Pat. App. Ser. No. 61/818,736, filed May 2, 2013 and incorporated herein by reference.

### FIELD OF THE INVENTION

The present invention generally relates to data storage and optimization, and, more specifically, to systems and methods for efficiently and effectively propagating changes to information in a database across multiple media platforms.

### BACKGROUND OF THE INVENTION

The Internet comprises a vast number of computers and computer networks that are interconnected through communication links. The interconnected computers exchange information using various services. In particular, a server computer system, referred to herein as a web server, may connect through the Internet to a remote client computer system and may send, to the remote client computer system upon request, one or more websites containing one or more graphical and textual web pages of information. A request is made to the web server by visiting the website's address, known as a Uniform Resource Locator (“URL”). Upon receipt, the requesting device can display the web pages. The request and display of the websites are typically conducted using a browser. A browser is a special-purpose application program that effects the requesting of web pages and the displaying of web pages.

Browsers are able to locate specific websites because each website, resource, and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A URL is much easier to remember and may be used to point to any computer, directory, or file on the Internet. A browser is able to access a website on the Internet through the use of a URL. The URL may include a Hypertext Transfer Protocol (HTTP) request combined with the website's Internet address, also known as the website's domain name. An example of a URL with a HTTP request and domain name is: http://www.companyname.com. In this example, the “http” identifies the URL as a HTTP request and the “companyname.com” is the domain name.

Domain names are much easier to remember and use than their corresponding IP addresses. The Internet Corporation for Assigned Names and Numbers (ICANN) approves some Generic Top-Level Domains (gTLD) and delegates the responsibility to a particular organization (a “registry”) for maintaining an authoritative source for the registered domain names within a TLD and their corresponding IP addresses. For certain TLDs (e.g., .biz, .info, .name, and .org) the registry is also the authoritative source for contact information related to the domain name and is referred to as a “thick” registry. For other TLDs (e.g., .com and .net) only the domain name, registrar identification, and name server information is stored within the registry, and a registrar is the authoritative source for the contact information related to the domain name. Such registries are referred to as “thin” registries. Most gTLDs are organized through a central domain name Shared Registration System (SRS) based on their TLD.

The process for registering a domain name with .com, .net, .org, and some other TLDs allows an Internet user to use an ICANN-accredited registrar to register their domain name. For example, if an Internet user, John Doe, wishes to register the domain name “mycompany.com,” John Doe may initially determine whether the desired domain name is available by contacting a domain name registrar. The Internet user may make this contact using the registrar's webpage and typing the desired domain name into a field on the registrar's webpage created for this purpose. Upon receiving the request from the Internet user, the registrar may ascertain whether “mycompany.com” has already been registered by checking the SRS database associated with the TLD of the domain name. The results of the search then may be displayed on the webpage to thereby notify the Internet user of the availability of the domain name. If the domain name is available, the Internet user may proceed with the registration process. Otherwise, the Internet user may keep selecting alternative domain names until an available domain name is found. Domain names are typically registered for a period of one to ten years with first rights to continually re-register the domain name.

The information on web pages is in the form of programmed source code that the browser interprets to determine what to display on the requesting device. The source code may include document formats, objects, parameters, positioning instructions, and other code that is defined in one or more web programming or markup languages. One web programming language is HyperText Markup Language (“HTML”), and all web pages use it to some extent. HTML uses text indicators called tags to provide interpretation instructions to the browser. The tags specify the composition of design elements such as text, images, shapes, hyperlinks to other web pages, programming objects such as JAVA applets, form fields, tables, and other elements. The web page can be formatted for proper display on computer systems with widely varying display parameters, due to differences in screen size, resolution, processing power, and maximum download speeds.

Websites can be generated from structured data stored in a database or other data store. In a basic implementation, the data can include multiple records having a data type and content, and a web programming interface can access the database, retrieve records having the desired data types, and add the content of those records to one or more web pages. Additionally, data formats and schema exist that optimize the structured data for inclusion on a website. For example, the Microdata format is a set of HTML tags used to delineate types of data on a web page. Microdata tags can be used in conjunction with a defined data type vocabulary, such as that provided by schema.org, to retain information relating to the data type of data extracted from the database and placed on the website. Retaining such information allows Internet search engines to better understand the content of a website.

The Internet continues to be increasingly valuable to individuals and businesses alike. More people use the Web for everyday tasks, from social networking, shopping, banking, and paying bills to consuming media and entertainment. E-commerce is growing, with businesses delivering more services and content across the Internet, communicating and collaborating online, and inventing new ways to connect with each other. It is advantageous for individuals and businesses to maintain an online presence, which may include presenting information about the individual or business on multiple online platforms. For example, a business might have its own website at www.thebusiness.com, business listings on GOOGLE Places for Business and BING Places for Business, a profile page on FACEBOOK, one or more blast email lists and a mobile application (“app”) that customers download to their mobile device. These platforms can have different virtual locations (i.e. different domains) and partially or fully incompatible formats, despite sharing common information.

Information that is typically common across platforms normally includes the most important information. For individuals, this might be name, photo, phone number, TWITTER handle, blog or personal web page address, and the like. For businesses, this might be name, address, phone number, hours of operation, news feed, product information such as menus or inventory, and the like. Whether such information changes frequently or only on rare occasion, it is very important to the individual or business that the information is consistently presented across all of its online platforms. Unfortunately, the incompatibilities between platforms can require the individual or business to either manually update the information multiple times, or engage a web design firm to maintain the information at some expense and with some risk of errors or omissions as the information is repeatedly updated.

Relatedly, an individual or business may wish to maintain a consistent visual presentation, referred to herein as a theme, across its platforms. Platform incompatibility may prevent or limit the consistency of the theme. For example, color schemes, graphic elements, and layouts are all completely customizable for a standalone website, but FACEBOOK imposes a strict profile format where graphics and layout cannot be easily carried over. It would be advantageous to identify the elements of a theme that can be adapted for use on each platform, in order to best provide the desired consistent presentation. Further, changes to the theme could be more easily propagated across platforms.

Despite the increasing use of the Internet and other online or electronic platforms, individuals and businesses still have physical presences and use printed collateral to convey some of the information from their web presence. Again, the information conveyed on printed collateral, such as flyers, brochures, catalogs, business cards, newsletters, and the like, can include name, contact information, and other information that must be kept consistent. Additionally, printed collateral frequently determines or shares the theme or themes used online. Printed collateral can be designed electronically, using graphic design software such as ADOBE PHOTOSHOP, publishing software such as PAGEPLUS, and other software. These programs can store the information and graphics to be printed in design files that can be accessed by other programs or interfaces.

### BRIEF DESCRIPTION OF THE DRAWINGS

FIG. 1 is schematic diagram of a system and associated operating environment in accordance with the present disclosure.

FIG. 2 is a diagram of an example common data set for an individual.

FIG. 3 is a diagram of an example common data set for a business.

FIG. 4 is a diagram of a template for a website platform according to the present disclosure.

FIG. 5 is a diagram of a template for a social networking platform according to the present disclosure.

FIG. 6 is a diagram of a template for a first non-electronic platform according to the present disclosure.

FIG. 7 is a diagram of a template for a second non-electronic platform according to the present disclosure.

FIG. 8 is a flow diagram of a method for maintaining common data across multiple platforms according to the present disclosure.

FIG. 9 is a flow diagram of a method for formatting common data to be distributed to a platform according to the present disclosure.

FIG. 10 is a block diagram showing the functional components of a system for maintaining common data across multiple platforms according to the present disclosure.

FIG. 11 is a diagram of an exemplary automatically typeset paper menu using a first template.

FIG. 12A is a diagram of the exemplary menu of FIG. 11, automatically typeset for display on a website using the first template.

FIG. 12B is a diagram of the exemplary menu of FIG. 11, automatically typeset for display on a mobile website using the first template.

FIG. 13 is a diagram of the exemplary menu of FIG. 11, automatically typeset for display on a FACEBOOK page using the first template.

FIG. 14A is a diagram of the exemplary menu of FIG. 11, automatically typeset for display on a website using a second template.

FIG. 14B is a diagram of the exemplary menu of FIG. 11, automatically typeset for display on a mobile website using the second template.

FIG. 15 is a diagram of a second exemplary menu, automatically typeset for display on a social networking page using the second template.

FIG. 16 is a flow diagram of a method of columnating content in accordance with the present disclosure.

FIG. 17 is a diagram of a user interface displaying editables for changing and adding text content to a menu.

FIG. 18 is a flow diagram of a method of paginating content in accordance with the present disclosure.

FIG. 19 is a flow diagram of a method of typesetting a menu for display on a website.

FIG. 20 is another diagram of a user interface displaying editables for changing and adding text content to a menu.

### DETAILED DESCRIPTION OF THE PREFERRED EMBODIMENT

The present invention overcomes the aforementioned drawbacks by providing a system and method for the maintenance of a user's common data across multiple media platforms by storing the common data as structured data in a database, formatting the common data according to one or more display formats required by each of the platforms, and transmitting the formatted common data either to the platform, to the user, or to an end-user, depending on the requirements of the platform. At least one of the platforms may be a website hosting service that provides the user's website to the public. The web server tasked with serving the website to requesting devices, also known as a hosting provider, may perform one or more algorithms for the data maintenance. Alternatively, the web server may assign the maintenance to a related computer system, such as another web server, collection of web or other servers, a dedicated data processing computer, or another computer capable of performing the maintenance algorithms. Alternatively, a standalone program may be delivered to and installed on a personal computing device, such as the user's desktop computer or mobile device, and the standalone program may be configured to cause the personal computing device to perform the maintenance algorithms. For clarity of explanation, and not to limit the implementation of the present methods, the methods are described below as being performed by a web server that serves the website to requesting devices. The creation of web pages, documents, and printed collateral is described with a left-sided prioritization for left-to-right reading countries; it will be understood that left and right directions may be reversed for right-to-left reading countries.

Common data, as used herein, may be any information that the user wants to accurately and consistently maintain across a plurality of publically available platforms. That is, the user may desire each element of common data to be the same on every platform. In accordance with the present disclosure, each common data element may be promptly updated on all or a subset of the platforms when the element is added or changed on one platform. A platform, as used herein, is a public or semi-private source of information on which a user may maintain information and allow the information to be presented to the public or to a limited audience. A platform may have one or more defined publishing formats that the web server can emulate, or for which the web server can provide format-ready content, as described further below. Platforms in accordance with this disclosure may include, without limitation: online platforms, such as websites, social network profiles, and content feeds and streams including RSS feeds, blogs and viogs, YOUTUBE channels and other video streaming services, and the like; downloadable and other offline digital platforms, such as electronic newsletters, blast emails, PDFs and other documents, programs, and the like; non-digital electronic platforms such as radio and television broadcasts; and non-electronic platforms, such as letterhead, flyers, brochures, print advertisements, and the like.

In one implementation, the present disclosure provides a method of obtaining content information for a product list. Obtaining the content information may include receiving a digitized copy of a paper version of the product list. Obtaining the content information may also include scraping a previous website containing the product list. The content information may include one or more common data elements for a plurality of platforms. The method further includes obtaining a template for configuring the content information for display with a unified layout on a plurality of the platforms. Obtaining the template may include receiving, from a user, a selection of the template from a plurality of template selections. The method further includes inserting the content information into the template. Inserting the content information into the template may include identifying, within the template, a plurality of template tags indicating locations within the template where structured data can be inserted, extracting the structured data from the content information, and inserting the structured data into the template at the locations of the template tags.

Inserting the content information into the template may also include parsing the content information into a plurality of content elements and columnating one or more of the content elements. Columnating one or more of the content elements may include determining a number of columns to display on a page, estimating a column height for each of the columns, and, until all content elements to be columnated are added to one of the columns, for each column: adding one of the content elements to the column; checking for an overflow of content beyond the column height; returning to the adding step if there is no overflow; and continuing to another column if there is an overflow. Columnating one or more of the content elements may further include rebalancing the content elements across the columns. Inserting the content information into the template may further include paginating one or more of the content elements. Paginating one or more of the content elements may include identifying a target element containing the content element, copying the target element to a new page, and adding the content element to the new page.

The template may have a markup component, a style component, and an image component. The markup component may include a plurality of editables. The plurality of platforms may include a website, a social networking page, a mobile website, and printed paper. Inserting the content information into the template may include typesetting the product list.

In another implementation, the present disclosure provides a system having at least one server computer in electronic communication with a computer network. The server computer is configured to obtain content information for a product list, the content information comprising one or more common data elements for a plurality of platforms. The server computer is further configured to obtain a template for configuring the content information for display with a unified layout on a plurality of the platforms. The server computer is further configured to insert the content information into the template such that the content information is typeset in a substantially similar layout. The server computer may be configured to insert the content information into the template by: identifying, within the template, a plurality of template tags indicating locations within the template where structured data can be inserted; extracting the structured data from the content information; and inserting the structured data into the template at the locations of the template tags.

The server computer may be configured to insert the content information into the template by parsing the content information into a plurality of content elements, and columnating one or more of the content elements. Columnating one or more of the content elements may include determining a number of columns to display on a page, estimating a column height for each of the columns, until all content elements to be columnated are added to one of the columns, for each column: adding one of the content elements to the column; checking for an overflow of content beyond the column height; returning to the adding step if there is no overflow; and continuing to another column if there is an overflow. Columnating the content elements may further include rebalancing the content elements across the columns. The server computer may be further configured to display, to a user, a user interface for editing a display of the product list on one or more of the platforms. The template may be generated by a template language and may include one or more editables, each editable being configured to receive input from the user without presenting the template language to the user. The plurality of platforms may include a website, a social networking page, a mobile website, and printed paper.

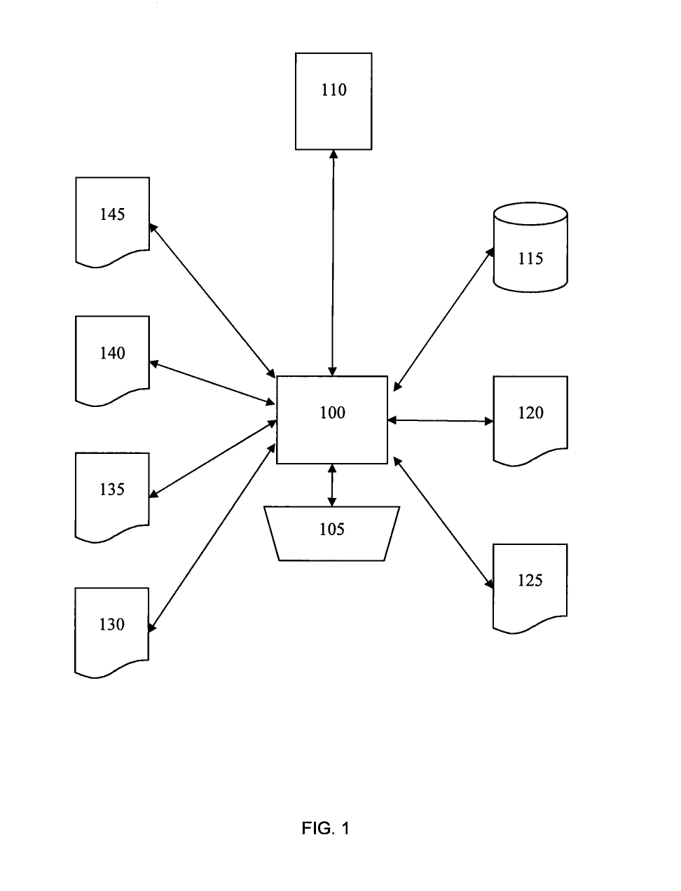

Referring to FIG. 1, a web server 100 may be configured to communicate electronically with one or more data stores in order to store, update, and retrieve information from the data stores. The electronic communication may be over the Internet using any suitable electronic communication medium, communication protocol, and computer software including, without limitation: a wired connection, WiFi or other wireless network, cellular network, or satellite network; TCP/IP or another open or encrypted protocol; browser software, application programming interfaces, middleware, or dedicated software programs. The electronic communication may be over another type of network, such as an intranet or virtual private network, or may be via direct wired communication interfaces or any other suitable interface for transmitting data electronically between a data store and the web server 100. In some embodiments, a data store may be a component of the web server 100, such as by being contained in a memory module or on a disk drive of the web server 100.

A data store may be any repository of information that is or can be made freely or securely accessible by the web server 100. Suitable data stores include, without limitation: databases or database systems, which may be a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, or other means of data storage located on a computer, client, server, or any other storage device known in the art or developed in the future; file systems; and electronic files such as web pages, spreadsheets, and documents. Each data store accessible by the web server 100 may contain information that is relevant to the maintenance of the user's common data, as described below.

In some embodiments, the common data may be stored as structured data in a content database 115. The common data may have any suitable format for storage, depending on the type of common data. That is, common data can be characters, integers or floating-point numbers, text strings, ordered or unordered lists, single-type or hybrid data structures, images, program code modules (i.e. compiled web application “widgets,” scripting language functions), pointers to other data (i.e. a URL or file location), files, and other objects. The common data may be structured at any suitable level of abstraction. For example, in a relational database the common data may be organized into one or more tables, including nested tables, while in an object-oriented database the common data may be organized into hierarchical data structures that parse the data into its simplest elements (e.g. an “address” structure is parsed into street address, city, state, and postal code).

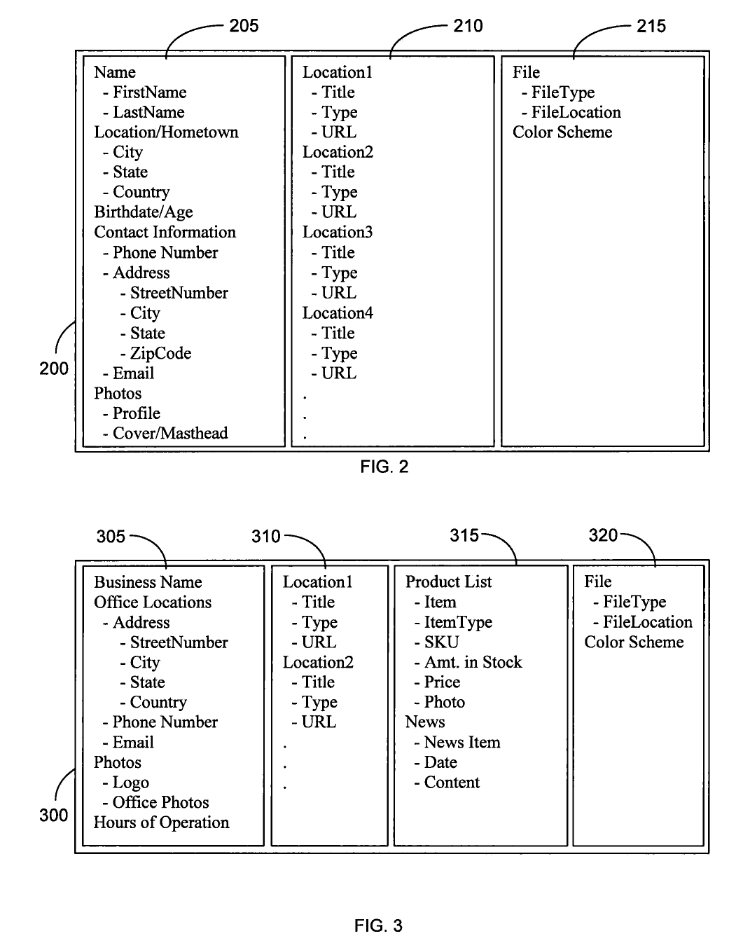

The common data may depend on the type of user. For example, as shown without limitation in FIG. 2, an individual's common data 200 may include a personal data set 205, an account data set 210, and a theme data set 215. The personal data set 205 may include data structures for name, location/hometown, birthdate (or simply age), contact information, and other data structures. The account data set 210 may include data structures for identifying online locations to which the user may want to direct visitors. Locations can include one or more social network profile pages, one or more personal websites, one or more favorite or relevant websites or web pages, and one or more content streams such as a blog, RSS or other feed, YOUTUBE channel, and the like. Data structures for the locations may include, for example, a location title, location type, and web address.

The theme data set 215 may include data structures representing elements of a theme to be maintained across platforms. A theme, as used herein, is a unifying design used when presenting information on each platform. The theme may include the graphics, layout, and other aspects of the presentation of the user's information, including common data. The data structures may include files, such as images, layout templates (e.g. HTML or MICROSOFT WORD templates), cascading style sheet (CSS) modules or other style sheets, and other program code files (i.e. PHP or Perl files). The data structures may further include color schemes, skins, and the like. Users can select a pre-built theme and may then have the option of modifying one or more attributes (e.g., color or design elements) of the pre-built theme. The attributes may be stored in a CSS file that can be utilized to control thematic elements across a number of platforms. The theme may also contain decorative elements (design elements), user preference relating to what display elements (e.g., information or widgets) are displayed on a particular website and how the display elements should be rendered, customizations of the overall color palette, font selection, image placement, and the like. This theme information can be stored in the content database 115 or another database.

In some cases, the user may specify a position of the elements within the theme or in a particular rendering. In some implementations, this positional information can be utilized to infer how the user wishes to use each piece of information or widget. This may enable, for example, mapping display elements to be pulled from a website and utilized within the user's twitter profile page.

FIG. 3 illustrates an example of common data 300 for a business. The business common data 300 may include a basic data set 305, an account data set 310, a content data set 315, and a theme data set 320. The basic data set 305 may include data structures for business name, office location and contact information, photos, and business hours of operation. The account data set 310 may include data structures for identifying online locations, as in the account data set 210 of FIG. 2 described above. The content data set 315 may include data structures for the business' products. A product list may be a menu, partial or full catalog, inventory, or similar list. The content data set 315 may include other data structures to relate information across multiple platforms, such as a news item data structure. The theme data set 320 may include data structures for the business' theme as in the theme data set 215 of FIG. 2 described above.

The web server 100 may maintain the common data using one or a combination of any suitable database querying and control schema, such as MySQL, Oracle, IBM DB2, or another relational database management system, JADE, DB4O, or another object-oriented database management system, or other schema and associated systems. Maintaining the common data may include executing queries or instructions upon the content database 115 in order to store new data elements, update or delete existing data elements, and retrieve data elements for distribution to one or more of the platforms.

Referring again to FIG. 1 and as described above, the user, which may be an individual or group of individuals, or a business or other organization represented by an employee, third party, or other agent, may access the web server 100 using an interface 105. The interface 105 may be located on the web server 100 and communicated to the user over the Internet or another computer network. Alternatively, the interface 105 may be located on a device accessible to the user, such as a desktop or laptop computer, tablet computer, smartphone, personal data assistant, server, mainframe, and the like. Alternatively, the interface 105 may be located on one or more of the platforms. The platforms may include one or more website hosting platforms 120 (e.g. GODADDY Web Hosting), one or more social networking/profile listing platforms 125 (e.g. FACEBOOK, TWITTER, GOOGLE Places for Business), one or more content feed platforms 130 (e.g. YOUTUBE, WORDPRESS), one or more digital offline or downloadable-content platforms 135 (e.g. AMAZON Simple Email Service, FTP server), one or more non-digital electronic platforms 140 (e.g. television, radio), and one or more non-electronic collateral creation platforms 145 (e.g. printed media layout and publishing software), with which the web server 100 may be in electronic communication in order to send or receive data. In general, the web server 100 may be configured to communicate electronically with any suitable platform in order to perform the common data maintenance in accordance with this disclosure. A platform may comprise one or more local data stores. The local data store may be directly accessible by the web server 100, or the respective platform may have an interface, such as an application programming interface (API) or another database frontend, through which the web server 100 may transmit and receive data.

In some embodiments, one or more of the local data stores may contain its own instance of the common data, which exists separately from the centrally-maintained instance of the common data within the content database 115. To maintain consistency of the common data in these embodiments, the web server 100 may retrieve current common data from the content database 115 according to the methods described herein, and transmit it to one or more of the platforms, or each platform may, periodically or upon an event, query the web server 100 for the most current common data. With its locally-stored common data updated, each platform may then format the common data according to its native formats. In other embodiments, a single instance of the common data may be maintained in the content database 115. The web server 100 may retrieve, format, and deliver the common data to one or more of the platforms as described further below. The local data stores do not retain a copy of the common data per se, but store the formatted data as delivered by the web server 100.

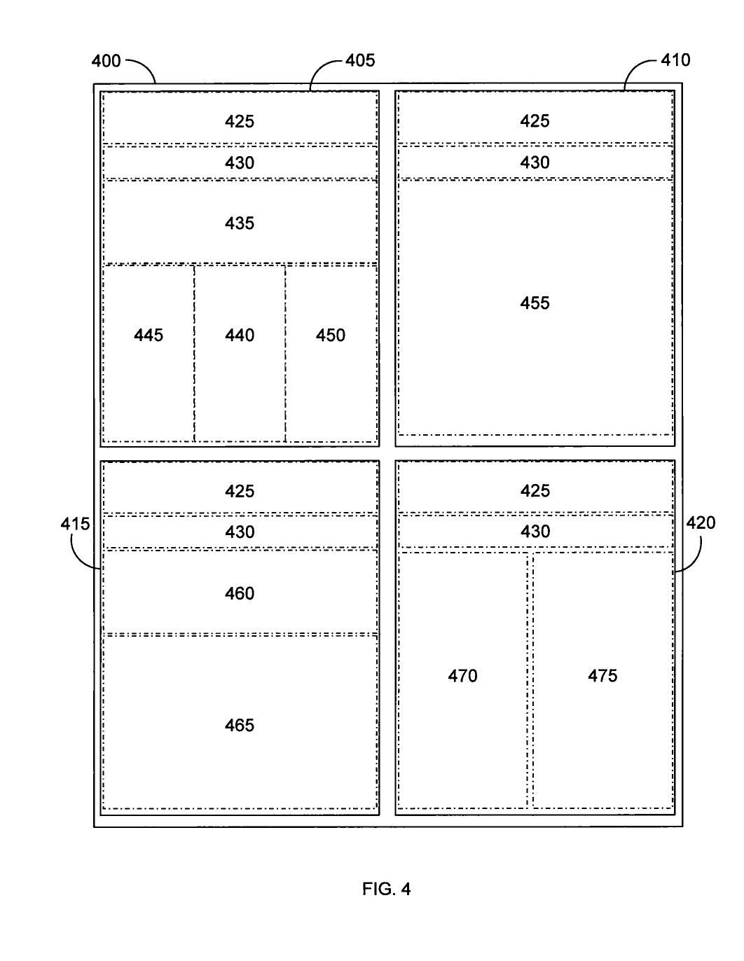

One or more of the platforms may have one or more predefined publication formats in which the common data and other content should be placed for publication on the associated platform. A platform format may be a file type or a combination of file types that the platform uses to publish data. A platform format may additionally or alternatively be a template, theme, layout, or other organizational scheme that coordinates data elements for display in the publication. In some embodiments, the platform format may include a data element identification scheme, such as a metadata tag scheme, that the web server 100 can access to determine which common data elements should be included in the format. The platform format may further inform the web server 100 how to size and stylize the common data elements and where to place them. FIGS. 4-7 illustrate non-limiting examples of platform formats for certain platforms.

FIG. 4 illustrates an example template 400 for a user's website, wherein the user is a restaurant. The template 400 includes page layouts 405-420 for a plurality of web pages: a “home” page layout 405 for displaying basic information; a “menu” page layout 410 for displaying the menu; an “about” page layout 415 for displaying restaurant background, such as history of the restaurant or biographies of the owners or chef; and a “contact” page layout 420 for displaying addresses, phone numbers, driving directions, email feedback forms, and the like. Each page layout 405-420 includes one or more content regions 425-475 for receiving and displaying content, which may include common data. Each content region 425-475 may be tagged with a content identifier. For each content region 425-475 that contains common data, the web server 100 is configured to recognize that content region's content identifier and associate it with the corresponding common data as the common data is structured in the content database 115. The web server 100 may thereby ascertain whether common data needs to be extracted from or updated on the user's website, according to the methods described below.

In the illustrated example template 400, each page layout 405-420 includes a masthead region 425 and a navigation region 430. The masthead region 425 may display the entity's name, logo, other graphics, or a combination thereof. The web server 100 may determine that the masthead region 425 contains common data elements from at least the basic data set 305 (i.e. entity name and logo), and potentially also the theme data set 320 (i.e. other graphics or colors). The navigation region 430 may display internal links to other web pages in the website and may contain colors or other common data from the theme data set 320. The home page layout 405 further contains a main graphic region 435, an attraction region 440, a location region 445, and a news region 450. The main graphic region 435 displays a relevant and eye-catching graphic, such as a photo of the storefront or of a dish served at the restaurant. The attraction region 440 displays relevant and eye-catching text information, such as the restaurant's specials or other data that may be common data located in the content data set 315 or another data set. The location region 445 displays important contact information, such as a map locating the restaurant and the restaurant's address and phone number. The web server 100 may determine that the displayed information is common data from the basic data set 305. The news region 750 displays recent information published about the restaurant, which may be common data stored in the content data set 315.

The menu page layout 410 may further include a menu region 455 for displaying the restaurant's menu, which may be in the content data set 315. The about page layout 415 may further include a bio image region 460 and a biography region 465. The bio image region 460 displays a relevant graphic, such as a photo of the storefront or restaurant owners, which may be common data in the basic data set 305. The biography region 465 displays a narrative regarding the restaurant and its owners. While not illustrated in FIG. 3, the narrative may be common data stored in one of the illustrated data sets, such as the content data set 315, or another data set. The contact page layout 420 may further include an info region 470 and a feedback region 475. The info region 470 displays contact information, such as phone number, address, map, and the like. The web server 100 may determine that the displayed information is common data from the basic data set 305. The feedback region 475 displays a form for website visitors to fill out and submit to the restaurant. The form structure may be stored in the template.

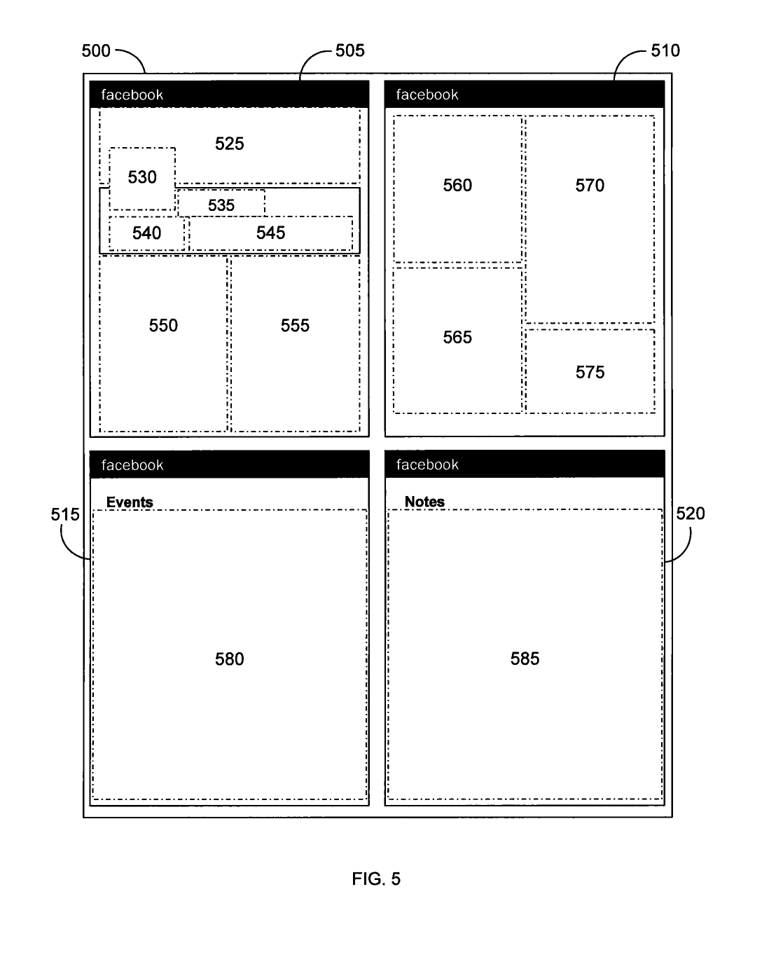

FIG. 5 illustrates a templated FACEBOOK layout 500 for the restaurant that has the website of FIG. 4. The FACEBOOK layout 500 includes page layouts 505-420 for a plurality of web pages: a “home” page layout 505 for displaying the restaurant's profile information; an “about” page layout 510 for displaying maps, addresses, phone numbers, other contact information, and biographical information; an “events” page layout 515 for displaying events at the restaurant; and a “notes” page layout 520 for displaying commentary by the restaurant. Each page layout 505-520 includes one or more content regions 525-585 for receiving and displaying content, which may include common data. Each content region 525-585 may be tagged with a content identifier. For each content region 525-585 that contains common data, the web server 100 is configured to recognize that content region's content identifier and associate it with the corresponding common data as the common data is structured in the content database 115. In some embodiments, the content identifier for a region 525-585 may match a corresponding region 425-475 of the template 400 that contains the same common data as the region 525-585 on the FACEBOOK layout 500. In other embodiments, the FACEBOOK layout 500 may have different region identifiers from the template 400 that the web server 100 is nevertheless configured to recognize. The web server 100 may thereby ascertain whether common data needs to be extracted from or updated on the user's FACEBOOK profile, according to the methods described below.

In the illustrated example home page layout 505, a cover photo region 525 displays a photo which may be common data from one of the data sets in the content database 115. A profile photo region 530 displays another common photo, such as the restaurant's logo, which may be in the basic data set 305. An entity name region 535 displays the restaurant's name, which is common data in the basic data set 305. A basic information region 540 displays the restaurant's address, phone number, hours of operation, type of cuisine, and other common data from the basic data set 305. A navigation region 545 displays internal links to other pages of the user's FACEBOOK profile. News regions 550, 555 display recent information published about the restaurant, some of which may be common data stored in the content data set 315.

The about page layout 510 may include a map region 560 for displaying a mapped location of the restaurant, which may be derived from address information in the basic data set 305. A biography region 565 displays a narrative regarding the restaurant and its owners. While not illustrated in FIG. 3, the narrative may be common data stored in one of the illustrated data sets, such as the content data set 315, or another data set. A restaurant info region 570 displays contact information, such as phone number, address, hours of operation, and the like, which may include common data from the basic data set 305. A platforms region 575 displays links to other online platforms where the restaurant has a presence. The information for the links may include common data from the account data set 310.

The events page layout 515 may include an event list region 580 for listing information about events at the restaurant. For example, an event can include a title, photo, date, time, and cost, which may be common data elements stored in an event data structure in the content data set 315. Similarly, the notes page layout 520 may include a list of notes, news items, articles, or other content, each item being stored in a data structure as common data in the content data set 315.

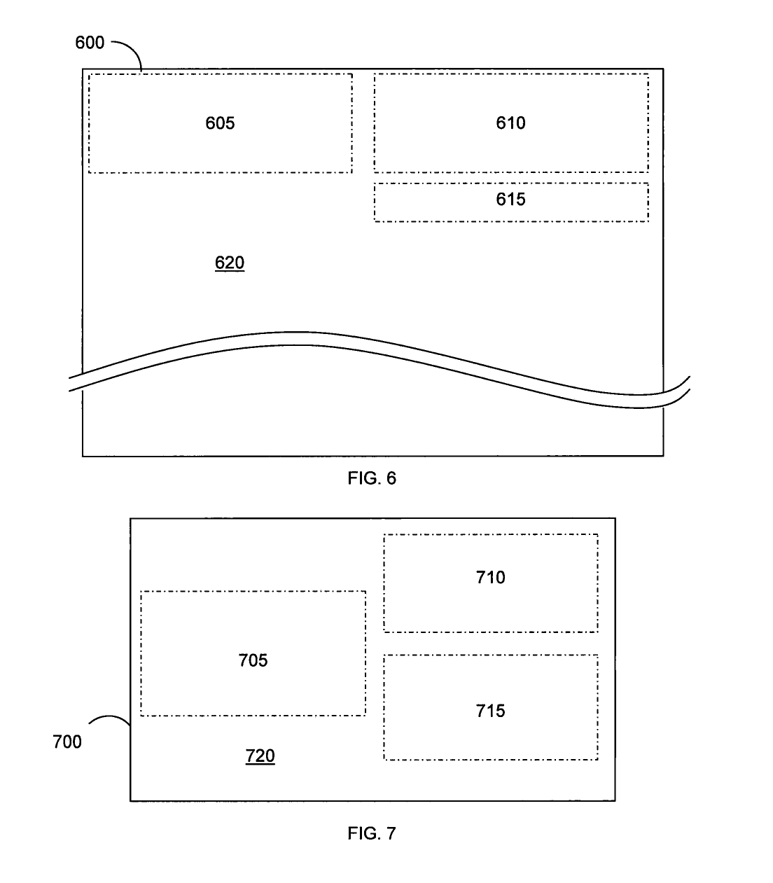

FIG. 6 illustrates an example template for a letterhead 600, and FIG. 7 illustrates an example template for a business card 700, for the business that has the website of FIG. 4. The templates may be used in a software program for generating layouts of the letterhead 600 and business card 700, before the letterhead and business cards are printed, and the templates may include identifiable regions, as described with respect to FIGS. 4 and 5 above, that the web server 100 may use to identify common data to be inserted into the regions. In each example template 600, 700, a logo region 605, 705 displays the business logo, which may be common data in the basic data set 305. An address region 610, 710 displays the contact information contained in the basic data set 305. An employee region 615, 715 includes data identifying the employee, which may be common data or other data that is extracted from a different data store. A background region 620, 720 may include graphics, colors, or other elements of a platform-spanning theme, which may be common data in the theme data set 320.

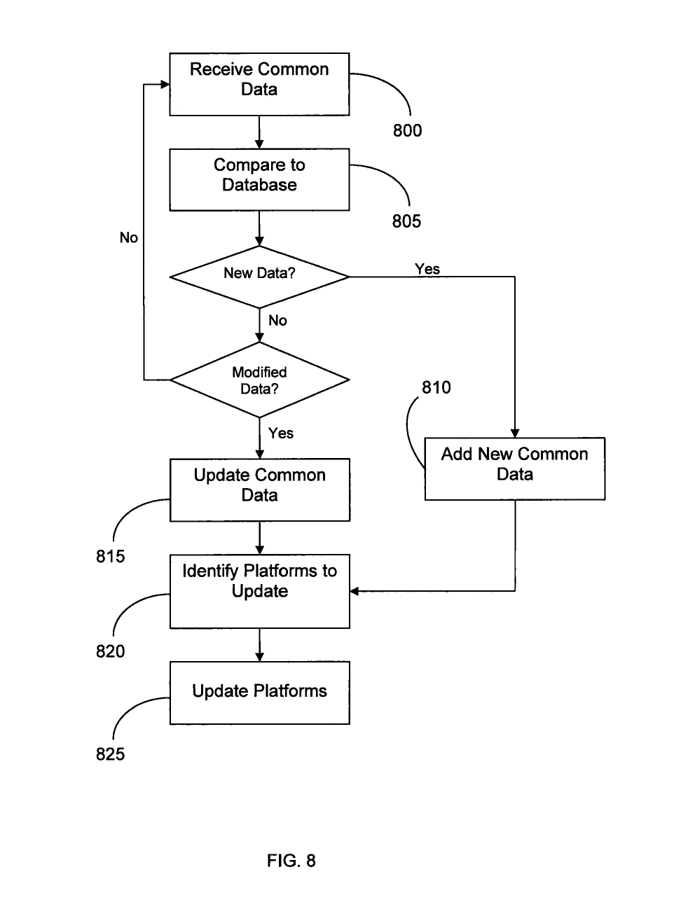

FIG. 8 illustrates an embodiment of a method the web server 100 may use to maintain the common data across multiple platforms. At step 800, the web server 100 may receive common data. The common data may be received from the user through an interface 105 as described above. The interface 105 may allow the user to identify the types of common data being entered, such as by providing one or more fillable forms or by allowing the user to generate its own data tags. Alternatively or additionally, the interface 105 or the web server 100 may be configured to analyze the entered common data to determine the data types and parse the data into data structures for storage in the content database 115. The web server may additionally or alternatively receive the common data at step 800 from one or more of the platforms with which the web server 100 is in communication. In some embodiments, the system of FIG. 1 may be configured so that when a user updates common data on one of the platforms, that platform transmits the changed or added common data to the web server 100. For example, when the user changes its profile photo on its FACEBOOK profile, the new photo may be transmitted to the web server 100 or retrieved by the web server 100. In that case, the user may provide the web server 100 with access credentials to access one or more platforms (such as FACEBOOK) using a suitable user account management system. Having been provided with credentials, the web server 100 can poll the platform through a suitable API, such as a FACEBOOK API, to determine whether information, such as text, photos, or videos, have been modified. If so, the web server 100 can retrieve the modified information to incorporate that information into the common data.

In other embodiments, the web server 100 or a separate interface (not shown) may be configured to periodically retrieve the common data from each platform, so that it is received on the web server 100.

At step 805, the web server 100 may compare the received common data to the common data stored in the content database 115. If necessary, the web server 100 may first identify the common data that was received. In some embodiments, the web server 100 may identify the common data using the data element identification scheme of each platform. Comparing the common data may include querying the content database 115 for the same data elements that were received at step 800 and determining if the data elements in the content database 115 match those received. If there are no data elements in the content database 115 that correspond to the received data elements, the received data elements comprise new common data that, at step 810, the web server 100 may add to the content database 115. Otherwise, if the data elements match, no update is needed, and if the data elements do not match, the web server 100 updates the common data in the content database 115 at step 815.

At step 820, the web server 100 identifies which platforms should be updated with the received common data. To enable accurate and precise updating of the platforms, each platform is analyzed to determine a purpose or function of each customizable element or data field provided by the platform. The common data is then analyzed to determine which types of common data map to the customizable elements or data fields offered by each platform. The suitability of particular data elements in the common data to map to particular elements or data fields of a platform can be scored using any appropriate scoring algorithm. One approach may include scoring the intent of each image on the user's common data in order to rank likelihood of that data to map to the receiving platform's configurable data field. For example, one component of Twitter profile banner photo scoring is knowing a large dominant image “hero image” on the home page of a website near the top middle is likely to map. Alternatively, the dimensions of images contained in the common data may be utilized to determine the suitability of a particular image for an image field of a particular platform. If the dimensions match or are sufficiently close to one another (e.g., their dimensions fall within a threshold range) the image in common data may be determined to be suitable for use in the platform's image

When updating a platform with new common data, the update may involve retransmitting all suitable common data (or a subset thereof) in new data transmissions or, alternatively, only transmitting or updating a delta from the old values stored with the platform.

In some embodiments, the content database 115 or another data store accessible by the web server 100 may include a structured list of platforms to which the common data should be delivered when it is updated. The structured list may also include, for each platform, access information such as a login/password combination that the web server 100 may use to deliver common data. As not all platforms may require every element of common data, the structured list may further include, for each platform, a sub-list of the common data elements that should be transmitted to the platform when such elements are changed. The sub-list of common data elements may include formats particular to each platform for one or more of the data elements. For example, a first format for a common profile photo may have a first size of 200×200 pixels for FACEBOOK and a second format may have a second size of 130×130 pixels for TWITTER. The structured list may additionally or alternatively include metadata tags or other identifiers that associate a particular data element with its appropriate element in a predefined publishing format.

At step 825, the web server 100 may update the platforms identified as needing an update of the common data. In some embodiments, the web server 100 may transmit the new or changed common data to the platforms in a raw or partially formatted state. Examples of such transmission include a raw data stream, raw or rich text file, or a data structure in a readable format such as XML, JSON, MICROSOFT EXCEL spreadsheet or MICROSOFT ACCESS database entries. Each platform may then extract the common data from the transmission and format the common data according to its own purposes. Alternatively, the new or changed common data may be transmitted to a platform using an API provided by the platform. In that case, the new or changed common data may be formatted in accordance with requirements established by that API. In some cases, the platform's API will be a publicly available API for which documentation is readily available. In other cases, the API will not be public and instead may be provided pursuant to an agreement between the platform owner and the operator of the web server 100.

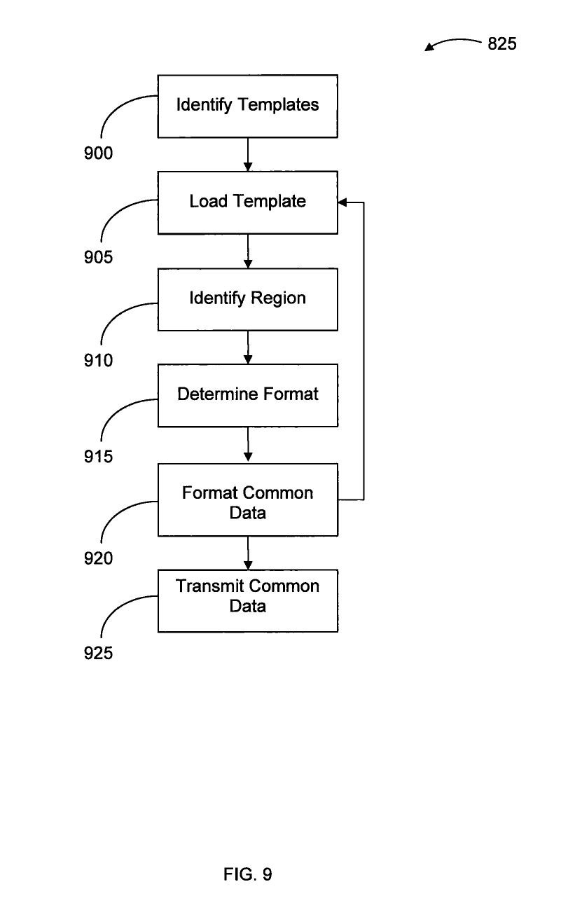

Additionally or alternatively, the web server 100 may format the common data according to one or more of the publishing formats used by each of the platforms. The web server 100 may retain or store in the content database 115 or another data store, one or more templates, such as those illustrated in FIG. 4-7, for each platform's publishing formats. Referring to FIG. 9, some embodiments of the step of updating the platforms may include, at step 900, identifying the templates of each platform that contain regions that should be updated with the common data.

For example, when publishing data to a third party platform, such as TWITTER or FACEBOOK, a number of techniques may be utilized to identify data stored within the common data that map to one or more display elements of the third party platform. For example, if a third party platform has a background image display element, a suitable image can be identified in the common data. One approach for identifying a suitable background image in the common data can include identifying an image that has been used as a background image in the user's website (or alternatively the background color of the user's website).

If a third party platform calls for a header image or cover photo, the common data can be analyzed using a scoring criteria to identify images that can be used as header images or cover photos. Example criteria that may be used to score an image include whether the image is used on the user's home page, whether the image is a “hero image” (i.e., the largest image on a web page, located at the top-middle of a web page, first image in a slideshow, etc.), whether the shape of the image matches the dimensions called for by the third party platform, and the like.

If a third party platform calls for a profile picture, the common data can be analyzed using a scoring criteria to identify images that can be used as profile images. Example criteria that may be used to score an image include whether an image in the common data has been placed into the user's website using absolute positioning, with more points being given to images located in the top-left of a web page and, if no pictures are on the left of the web page, more points are awarded to images on the right side of the web page, additional points may be given to images that are closer to the dimensions of a profile image (e.g., images that have square dimensions), the file name of the uploaded image (e.g., more points will be awarded to images that have file names of logo.gif), and the like.

In the specific case of the third party platform being TWITTER, the common data can be analyzed to determine a suitable list of handles that the user may wish to follow (and in some cases, the user's TWITTER account may be accessed to cause the account to follow the identified list of handles). For example, the common data may be utilized to identify an industry category for the user or the user's business. Then, based upon that industry determination, TWITTER's auto-follow API may be utilized to determine a list of handles to follow.

In some cases, the scoring criteria described above can be updated, refined, and otherwise modified based upon how often users modify images that are automatically selected from the common data.

At step 905, for each template, the web server 100 loads the template and then, at step 910, the web server 100 identifies the regions containing common data that should be changed. At step 915, the web server 100 determines, from HTML tags, metatags, or other formatting tags, how to format the common data for inclusion in the region. At step 920, the web server 100 formats the common data according to the determined format. The web server 100 may repeat steps 905-920 for each identified template. At step 925, the web server 100 transmits the formatted common data to the platform, by transmitting the template, the region, or the formatted data itself.

In accordance with the described system and methods, the web server 100 may create, from structured data stored in a content database 115, one or more web pages of a website. Furthermore, the web server 100 may receive some or all of the common data elements from the user during the website creation process, and may store or update the common data elements in one or more data structures. In one embodiment, the web server 100 may provide, through the interface 105, a series of prompts for receiving information that the user may want to display on the web pages. The prompts may be used to derive the proper templates to be used for creating the website. For example, the web server 100 may prompt the user to enter the type of business (i.e. restaurant, mechanic, massage parlor, etc.) that the website will promote. The user's input allows the web server 100 to select a template that has regions for containing the relevant content, or to select a subset of templates and provide the templates to the user for selection. The information provided by the user may include content information to be incorporated into the regions of the web page templates. The web server 100 may store the common data in data structures. The data structures may be stored in a database as described above, or alternatively the data structures may be stored as web pages in any suitable markup language. In the latter case, common data elements may be identified through Microdata or other tagging, so that the web server 100 may perform the common data maintenance methods described above by extracting elements from and storing elements within the web pages, rather than a central database.

Furthermore, the web server 100 may create different versions of the website in order to serve requested website content to requesting devices 110 of varying capabilities. A requesting device 110 may be a device for which web pages are typically designed without concern for display, user interface, processing, or Internet bandwidth limitations, including without limitation personal and workplace computing systems such as desktops, laptops, and thin clients, each with a monitor or built-in large display (collectively “PCs”). A requesting device 110 may be a device that cannot display the informational and functional content of web pages that are designed for viewing on PCs. Such limited devices include mobile devices such as mobile phones and tablet computers, and may further include other similarly limited devices for which conventional websites are not ordinarily designed. Mobile devices, and mobile phones in particular, have a significantly smaller display size than PCs, and may further have significantly less processing power and, if receiving data over a cellular network, significantly less Internet bandwidth. The web server 100 may use the same data from the content database 115 used to create the website to also create publications across other platforms as described above.

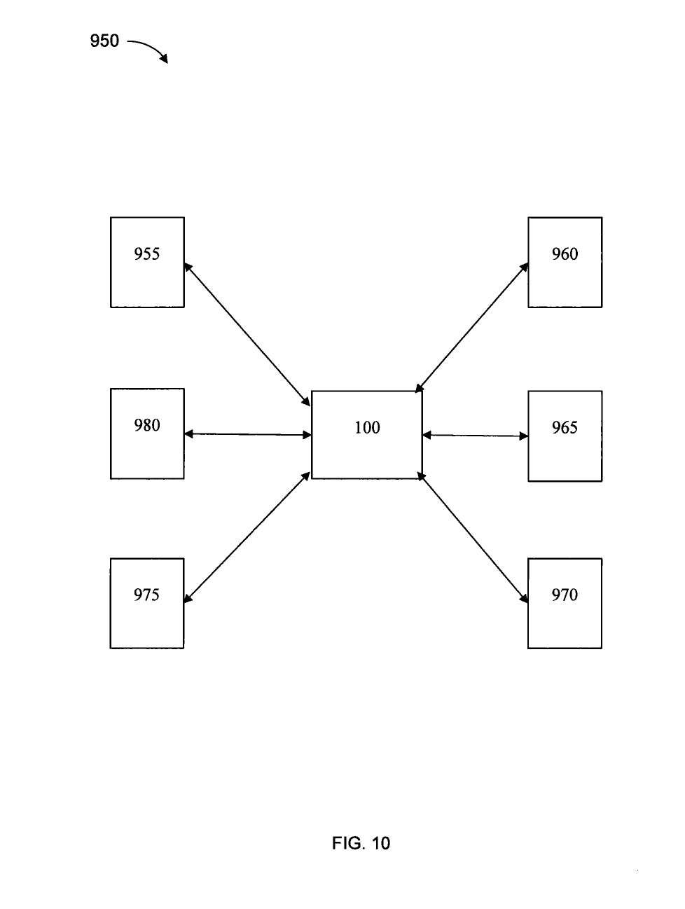

Referring to FIG. 10, a system 950 for performing the common data maintenance methods described above may include the web server 100 and a plurality of modules for performing one or more steps of the methods. The modules may be hardware or software-based processing modules located within the web server 100, in close physical vicinity to the web server 100, or remove from the web server 100 and implemented as standalone computer servers or as components of one or more additional servers. The modules may include, without limitation: a user interface module 955 for providing input/output capabilities between the system 950 and the user; a data retrieval module 960 for performing queries and modifications of the content database 115 and other data stores; a data processing module 965 for evaluating and comparing received and retrieved data; a formatting module 970, which may be a component of the data processing module 965 or a separate module, and which populates an identified template as described above and stores the template; one or more data storage modules 975 for storing templates, common data structuring paradigms, and related data; and a communication module 980 for communicating with the various platforms.

In some embodiments, a consistent and unified brand or appearance across multiple platforms may be achieved using the above systems and methods to perform automatic typesetting of product lists (e.g., menus, price lists, and the like). For example, a restaurant may market its restaurant services online and offline by displaying its menus on paper in their physical locations, on its website and mobile website, and on publisher sites such as FACEBOOK, Open Table, and TripAdvisor. According to the present disclosure, each of these product lists can be made to convey a single consistent and unified brand without the merchant having to work with a designer to manually design and typeset a product list for each of these mediums after every menu change. Additionally, the product lists rendered using this technique can be formatted so that they are easy to print and easy to include on any desired platform.

A template language may be used to design and specify a template that encodes a distinct brand in a way that spans multiple platforms and in a way that may be used to automatically render and typeset menus with professional looking results. In various embodiments, templates are described using a template language based on one or more markup languages such as HTML, CSS, LESS (dynamic CSS), and Handlebars. While any language that is expressive enough to create templates with support for multiple platforms may be used, one or more particular combinations of languages may be used to generate and manage the ‘editables’ described below. An exemplary embodiment describing the typesetting of cross-platform menus is described, but it will be understood that the method may be applied to cross-platform typesetting of any product list or other similar online content. The templates created by the template language may access the structured or unstructured data to be used as content by any of the data acquisition or distribution methods described above, such as by receiving a digitized version of a paper menu in the content database and performing OCR or another data gathering algorithm on the digitized version, or by scraping the data from an existing online version of the menu at a specified URL.

The template language described herein is designed to have a number of features for deploying a unified design across multiple platforms. The language may allow a single template to specify the look and feel for the rendered menu across multiple platforms. As a result, many of the portions of the design that look and feel the same across each platform do not have to be specified multiple times, which reduces the effort required of the template designers, and makes the template easier to maintain. The template language may be built using web technologies. The template language may be an expressive markup language or combination of languages (e.g., LESS and Handlebars) suitable for generating simple markup with advanced capabilities. The template language may exhibit cross-browser layout support for columns, page breaking, and intelligent pagination. The templates created from the template language may function within any suitable browser, including popular browsers such as INTERNET EXPLORER. The template language may use open-source fonts and may access any necessary electronic content (e.g., images) or other resources. It may support arbitrary positioning of text and images (such as a merchant's logo) giving designers freedom to implement the designs of their choosing.

The template language may have support for creating discrete portions of a template, referred to herein as ‘editables,’ that are exposed to the user for editing the content of the portion, without requiring the user to know the template language or to modify the source code of the web page. Templates may be parsed and their editables extracted and presented to the user using a simple user interface. In this way, a template designer may expose certain controls that they would like the user to have without requiring the user to manually modify the template markup. Both the template editor used by designers and the simple editor exposed to the user may include a live preview. This preview would update automatically so that the person making the changes can see in realtime what the effect of these changes is on the rendered and typeset menu for each platform.

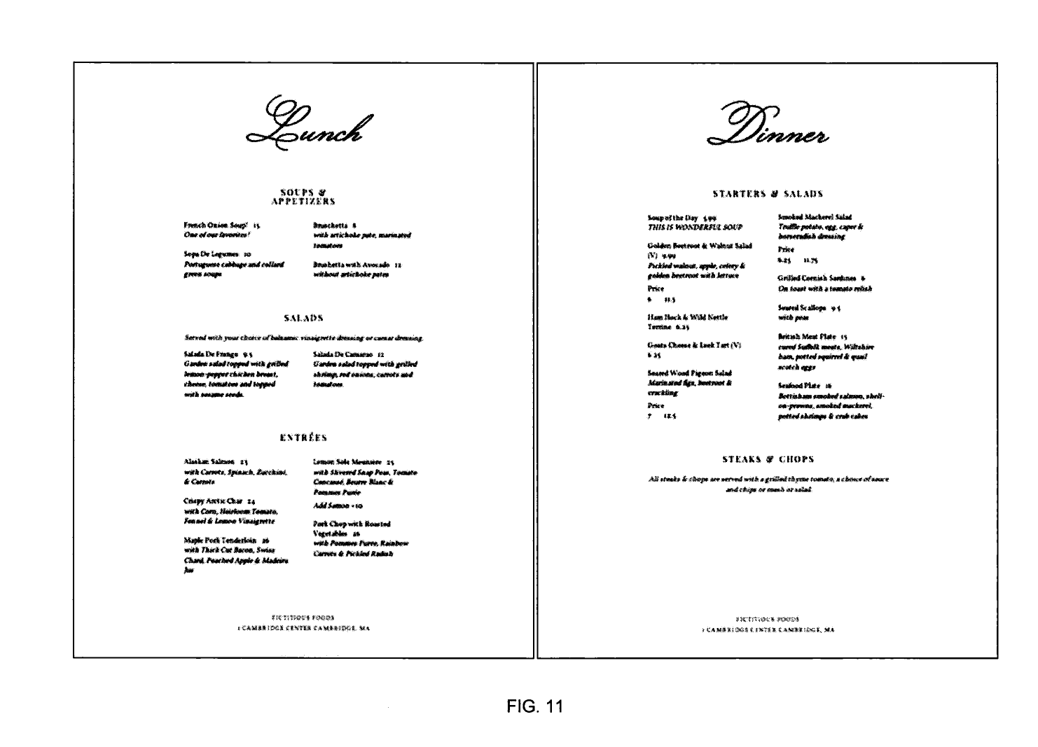

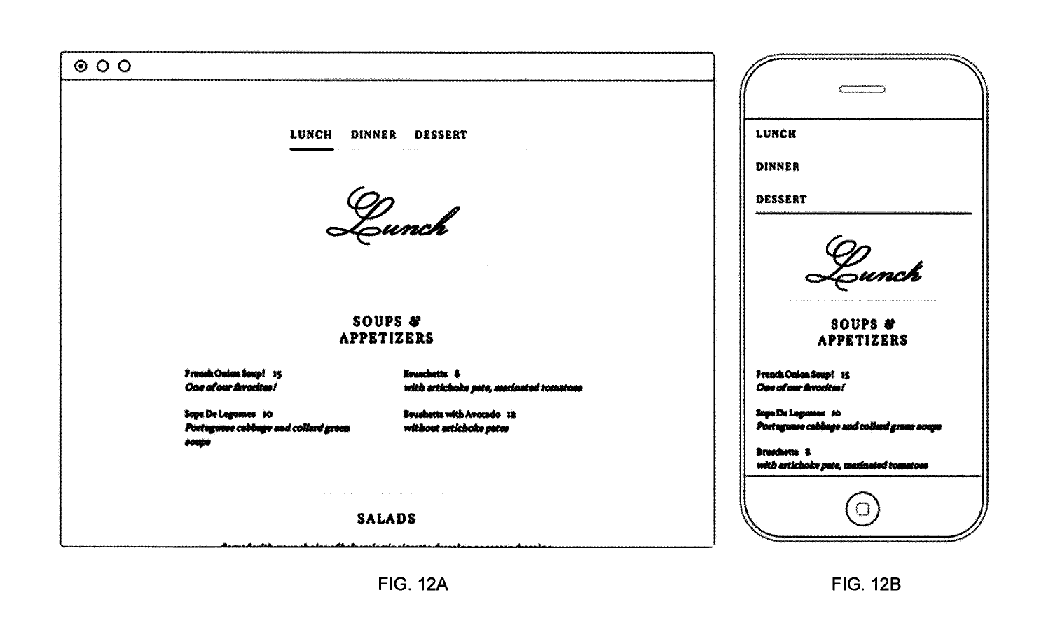

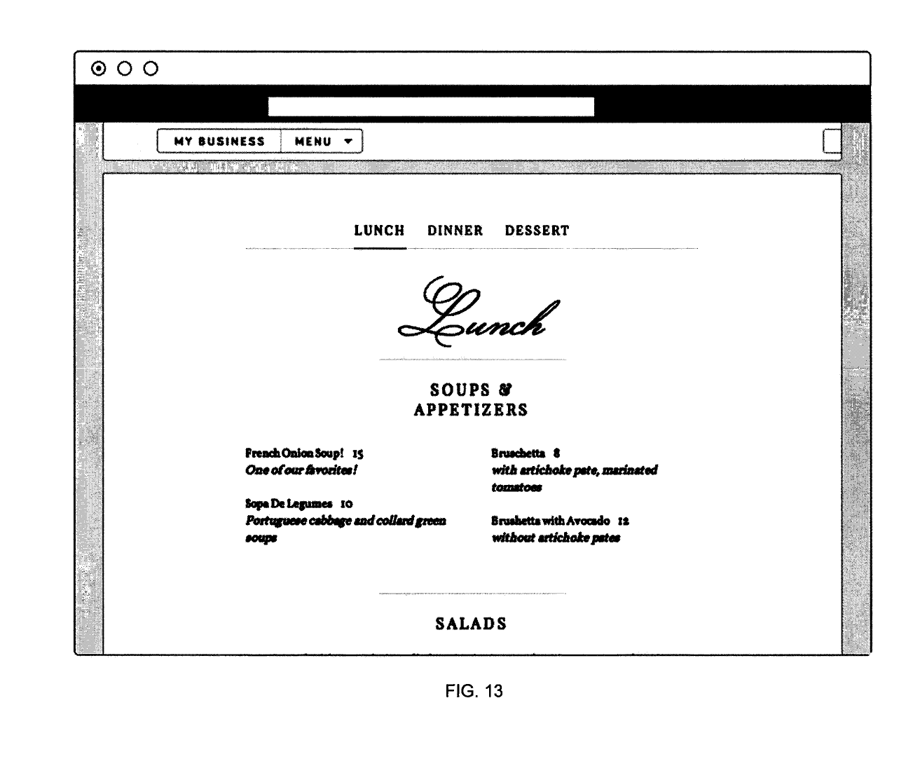

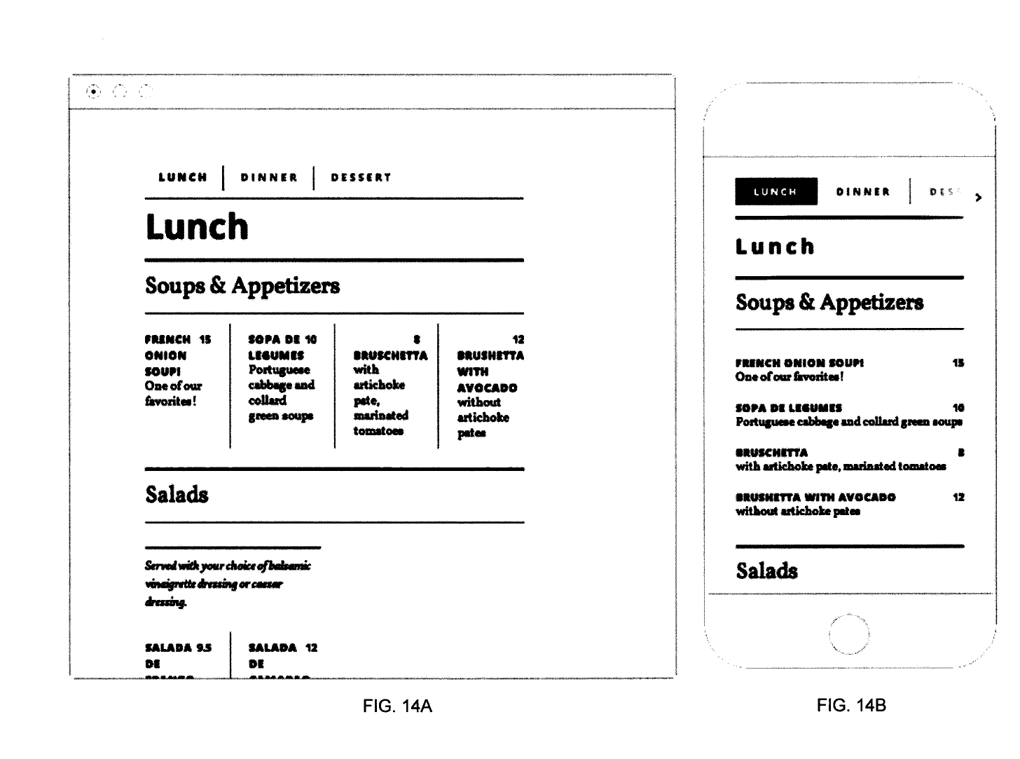

FIGS. 11-13 show an example menu rendered in a template across four different platforms, while FIGS. 14A-B show the same menu rendered for a website (FIG. 14A) and a mobile website (FIG. 14B) using a different template from that of FIGS. 11-13. Each of these examples may be rendered automatically using a template rendering algorithm according to the present disclosure. The examples illustrate the template language's ability to columnate sections of menu items, as well as to paginate the content across multiple pages. A template may be composed of three components: markup, style, and image. The markup component describes the structure of the menu design. In some embodiments, the markup component is based on HTML, and may contain any number of <div>, <span>, or other arbitrary HTML tags. The template may specify how the structured menu data should be rendered, such as by using Handlebars template tags, which allow for variable substitution and logical adaptation to make a template adaptable to different kinds of menu designs, based on the structured menu data being rendered.

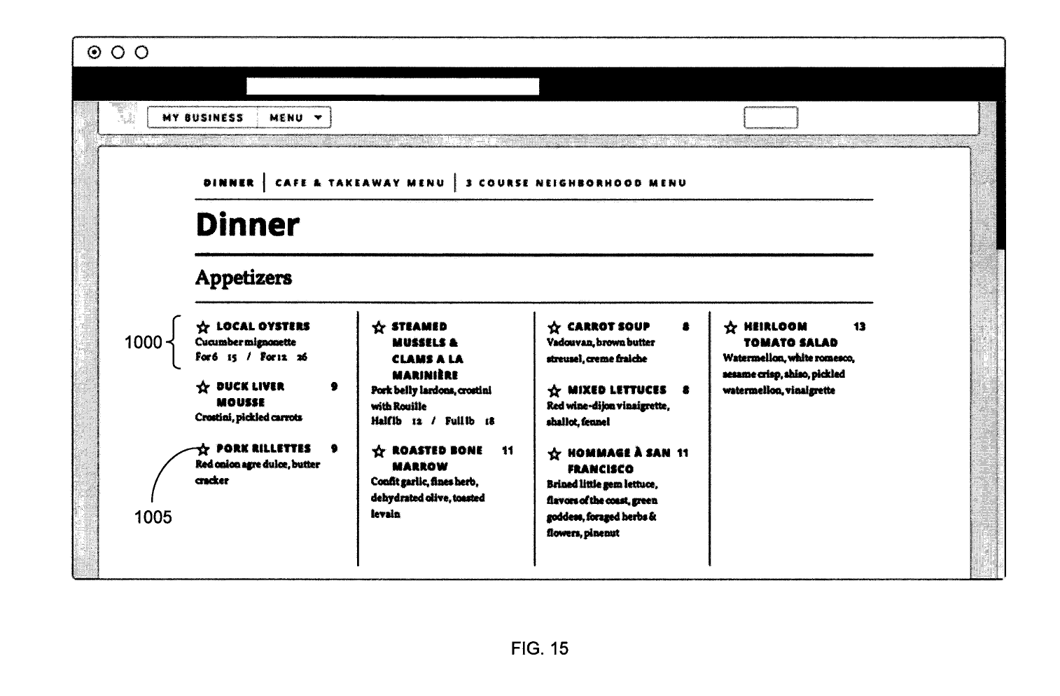

The markup component may be used to add interactive content to a menu on an electronic platform. Interactive content can be activated by a customer viewing the menu, such as by the customer clicking or scrolling over the interactive content. Activating the interactive content may cause one or more functions to be executed. For example, FIG. 15 illustrates a menu to be displayed on a social networking profile. Each menu item 1000 may be displayed with an icon 1005 that, when clicked, shares the menu or the menu item with the customer's social network (e.g., a Facebook user clicking on the icon 1005 “likes” the menu item, which adds a hyperlink to the menu item on the Facebook user's news feed).

The style component describes the appearance of the menu. Any suitable style-setting program function, such as a CSS or LESS rule, may be supported in the style component of the template. The style component may include one or more platform selectors that allow template designers to target various rules to specific platforms. For example, it may be desirable to create rules that target only the mobile website platform or only the Facebook platform (e.g., to specify different numbers of columns to be used in contrast to other selected platforms). The style component may support function calls to columniation and pagination algorithms, described herein, that organize the visual presentation of content within the context of one or more pages.

The columniation algorithm associated with the menu template language may be efficient, support paginated content, and support ‘smart columniation.’ With smart columniation, the number of columns used to display the content elements may be automatically inferred based on content, resulting in a functional and visually appealing use of blank space. In particular, smart columniation can be used to maintain a similar density of text across columns. For web-based platforms, this columniation algorithm may be used instead of a browser's own columniation algorithm, enabling support for columns even on browsers that do not support it and overriding less favorable columniation formats.

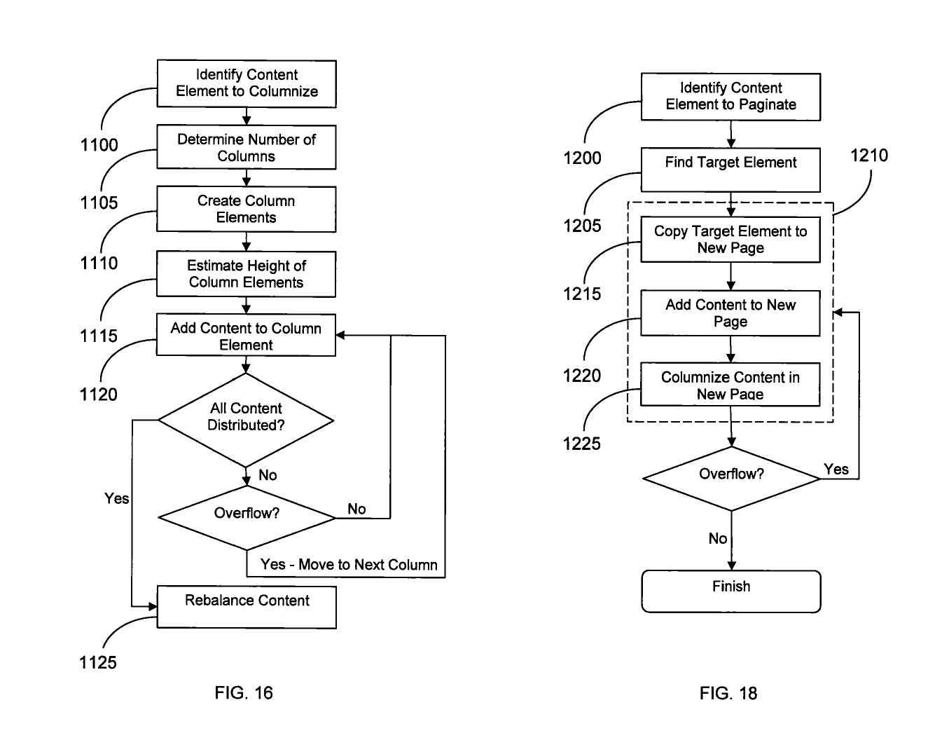

In some embodiments, the template may apply an indicator, such as a CSS class or other attribute, to each content element that is subject to columniation. Referring to FIG. 16, one embodiment of a columniation algorithm first identifies a content element that should be columnated, at step 1100, and proceeds as follows:
at step 1105, determine how many columns should be shown based on the content in this element by examining the length of the content, whether or not the content has certain subcontent (e.g. whether or not the section is composed of menu items that have descriptions as subcontent), and other signals, resulting in N columns of approximately equal height;
at step 1110, create N column elements and add them as children to the content element;
at step 1115, estimate the height of each column element, the column height being the maximum (i.e., the tallest column) that may be presented within the available space on the page;
at step 1120, recursively add content from the content element to the column elements until the column length of each column element is overflowed, proceeding to the next column element at overflow and duplicating any parent elements that span multiple columns until all content is distributed;
at step 1125, once content is distributed, rebalance content across column elements if the columns vary in height significantly.

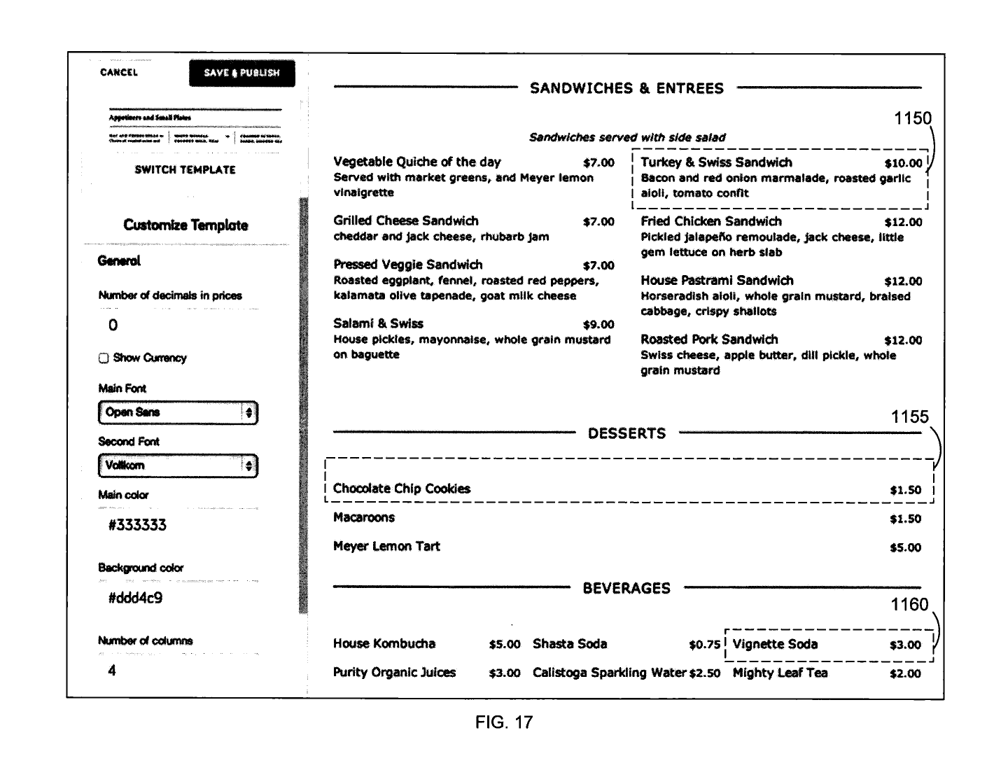

FIG. 17 illustrates an example result from executing the smart columniation algorithm. To maintain a visually appealing balance of text density, content elements 1150 that have three sub-elements—title, price, and description—are displayed in a two-column format, while content elements that have a title and price but no description are arranged differently. In the example, content elements 1155 that are part of a short list (e.g., three or fewer content elements 1155) may be too few for a visually pleasing distribution across multiple columns, and so are displayed in a single column, while content elements 1160 that are part of a long list (e.g., six or more content elements 1160) are distributed across three columns.

The pagination algorithm associated with the menu template language may break up menu content that cannot fit on one page. A “page” in this sense may be a physical space on a printed menu, or a virtual space on an electronic medium, such as the space visible on a monitor or on a virtual representation of a physical page. The pagination algorithm, when executed subsequent to or without the columniation algorithm, may include support for splitting up elements that have contents displayed with multiple columns. In some embodiments, the pagination algorithm may prevent “widowing” and “orphaning” of content, wherein sections of text or other display elements that should be displayed together are split across multiple pages.

The template language may include one or more attributes, such as CSS attributes, that may be used to specify whether a content element should not be placed last on a page (thus potentially widowed) or first on a page (thus potentially orphaned). The attributes may further or alternatively indicate that the constituents of the content element, such as text or image subelements, should not be separated across multiple pages from each other. A template may thereby include rules that specify that titles should not appear on their own on the bottom of a page, or that a single menu item should not appear by itself at the top of a new page. The pagination algorithm may read these attributes and execute one or more positioning decisions to best position each item of text in the menu to maximize both readability and aesthetic appeal.

Referring to FIG. 18, an embodiment of a pagination algorithm avoids widowing and orphaning by, at step 1200, identifying, such as by using the above-described indicator, a content element that should be paginated, and paginating the content element as follows:
at step 1205, find the target element (i.e., the element representing the page) that should contain the paginated content element;
while content remains in the content element, repeatedly perform the following, the repetition loop represented by step 1210:
   at step 1215, copy the target element to create a new page;
   at step 1220, recursively add content from the content element into the new page;
   at step 1225, apply columniation (as described above) required by the copied content element, using the remaining space available on the new page as a max-column height setting in the columniation algorithm;
   if overflow on the page occurs, repeat the loop 1210, duplicating any parent elements that span both pages.

In order to support cross-browser columniation and pagination, the columniation and pagination attributes may be stored in the style component of the template. The attributes may be retrieved with a custom source code parser. However, such retrieval can be slow when done in the browser via Javascript. It would be desirable to leverage the browser's CSS parser to retrieve the attributes, which can improve performance of the menu renderer, and may also reduce complexity significantly, because the leveraged browser's parser does not need to use non-native parsing function calls, which add overhead to the parsing operation and must be homogenized across different browsers to operate correctly. However, because current browsers ignore CSS attributes that are not known or supported by them, it is not possible to add new attributes. To overcome this limitation, the present algorithms may repurpose existing obsolete or infrequently-used CSS attributes to encode new attributes. For example, the cross-browser columnizer described herein uses the ‘list-style-image’ CSS attribute, which is commonly known to but unused by current browsers, to encode the column details:

```
list-style-image:
url(″blank_image_file.png?
  locucolumns_{number_of_columns}_{column_width}_{column_gap}_
  [style_rule]″).
```

The list-style-image attribute typically receives a URL parameter linking to an image file to be displayed in place of the default list item marker (i.e., a bullet point). In the present example of repurposing this attribute, the template passes additional parameters attached to the URL for a placeholder image file name. Specifically, the template passes the “locucolumns” function call with parameters for formatting the columns on the page, including the number of columns, width of each column, gap between columns, and a style rule which may include instructions for drawing borders and other style instructions. The parser may execute the locucolumns function to perform initial formatting of the columns on the page. Thus, in one example:

list -style-image:
url(″blank_image_file.png?
locucolumns_4_auto_40px_[1px,%20solid, 10 %20%23999999]″);

the system may determine that “4” is the number of columns, “auto” is the column width, “40px” is the width, in pixels, of the gap between columns, and the style rule indicates that the columns each have a one-pixel wide, solid, light grey (color hex code #999999) border.

The images component of the template may specify any images that will be used for particular purposes in the template. For example, the images component may include image files that are displayed as dividers, such as horizontal and vertical lines between sections and columns, in the rendered content. The images component may also store and track images that are used in the content elements, such as an image of a menu item that appears next to the text description of the menu item. Alternatively, such “content images” may be stored in the markup section in association with the structured data for the menu. The images component may interact with the style and markup components to determine and save properties for content images. In some embodiments, the images component may “smart crop” one or more of the content images so that the image meets a dimensional requirement and still displays the focal point of the image.

When displayed on web-based platforms, a template may be rendered and loaded by a Javascript program code referred to as a menu widget. The menu widget may be designed to be easy to install on a website. It may require insertion of a line script tag into the location where the menu shall appear, as is known in the art. The line script tag may indicate the current platform (e.g., website, mobile website, social media page, etc.) so that the properly formatted menu is displayed by the widget. In various embodiments, the widget would place the rendered content at the location within the web page source code of the line script tag, filling up 100% of the available width and taking up the required height in the web page for the content. Additionally, once installed, the look and feel of the widget could be changed from the editor interface without requiring a reinstall of the widget.

The widget may be cross-origin and cross-domain supported. For example, the widget may be installed on any website regardless of the domain, fetching data from servers via a cross-domain call. The widget may further support search engine optimization (SEO). For example, the widget may use a subset of the Javascript programming language to perform the cross-domain call, and to render the template and data such that GOOGLE and other search engines may execute the source code for the template and data successfully prior to indexing the content on the web page that contains the embedded menu.

In some embodiments, changes made to the structured data representing the menu (e.g., changes to item titles, descriptions, or prices, made through the menu editor available to the user) may be reflected instantly on platforms embedding the widget. For example, the present systems and methods may include a push notification system that distributes the new content to the platforms. In this way, a customer reading a menu may be guaranteed that they are looking at the most up-to-date content available.

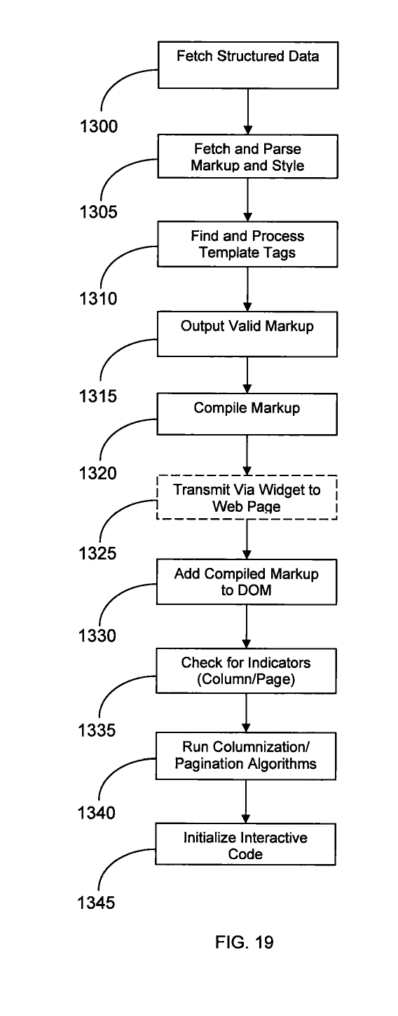

Referring to FIG. 19, rendering a menu and displaying the menu on a website or in the user interface for editing may be accomplished in the following manner:

at step 1300, the structured data for the menu may be fetched and preprocessed (see below);

at step 1305, the markup and style components of the template may be fetched and parsed such that the semantics of the markup are understood;

at step 1310, the markup compiler may find all template tags in the markup and style components and act on them accordingly. That is, for each template tag, the compiler may perform the following action based on the type of tag it finds:
a) If the template tag refers to an item of structured data, the compiler may replace it with the appropriate data for the tagged portion of the template;
b) If the template tag performs some control flow (e.g. an ‘if’ statement or a ‘loop’), the compiler may execute that control flow;
c) If the template tag is an editable tag, it may look up the editable value (set by the user) and replace the tag with this value (or the default if none is chosen);

at step 1315, the compiler may output valid HTML markup and valid LESS markup;

at step 1320, the LESS markup may be compiled with a LESS compiler, to construct the CSS required to style the menu in a browser;

optionally, at step 1325, content may be transmitted via a widget to a web page that embeds the widget using a cross-domain call implemented with a single Javascript tag;

at step 1330, using the browser, both the HTML and CSS outputs may be parsed and added to the document object model (DOM) of the target HTML document;

at step 1335, each element in the menu may be traversed and checked to see if it has any of the indicators that pagination or columniation needs to be performed;

at step 1340, if any such indicators are present, the pagination and/or columniation algorithms may be run, within the context of the browser, to update the positioning of each element in the DOM to its new location based on the pagination and columniation settings;

at step 1345, any javascript code required to make the menu interactive (e.g. for menu switching or for takeout) may be initialized before the menu is displayed in the browser.

Preprocessing structured data, such as in step 1300, may include normalizing and formatting the structured data. For example, the web server 100 may strip trailing spaces from data and reformat the data to replace unrecognized characters. Preprocessing may further include applying content classification schemes to the structured data. For example, a plurality of elements in the structured data may receive a common pricing configuration, such as if the elements appear on a value menu that changes prices depending on the time of day. Some or all of the steps of the presently described methods, including the method of FIG. 19, may be executed on the web server 100, or the steps may be executed in a browser on the user's device via the interface 105, or the steps may be executed by a combination of devices as described herein.

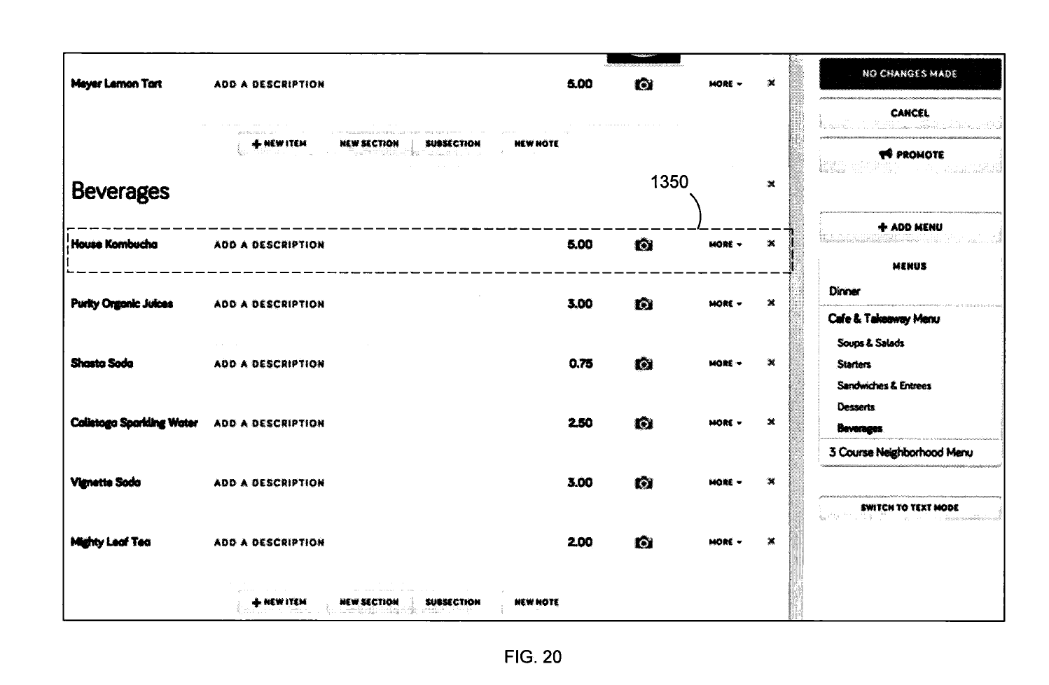

FIGS. 17 and 20 illustrate aspects of a user interface in which a “live preview” of the rendered menu is displayed next to or overlaid by customization controls that allow the user to set values for the editables within the menu. In FIG. 17, customization controls include a selector for switching between different available templates, and selectors, including text fields, drop-down menus, and radio buttons, for setting a plurality of general options to be applied to the rendered menu. The example customization controls are configured to set main and secondary fonts, the display of currency, colors of the fonts and background, and a default number of columns for the content. In FIG. 20, the customization controls are configured to set values for editables related to the “Beverages” section of the menu (of FIG. 17) and items 1350 associated with the section. In particular, for each item 1350, the customization controls allow the user to change the item 1350 name, add a description of the item 1350, change the price of the item 1350, upload an image to be displayed with the item 1350 on the menu, and perform additional modifications. The customization controls further allow the user to design additional menus and add sections and subsections to the menu.

The schematic flow chart diagrams included are generally set forth as logical flow-chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method. Arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present invention has been described in terms of one or more preferred embodiments, and it should be appreciated that many equivalents, alternatives, variations, and modifications, aside from those expressly stated, are possible and within the scope of the invention.

We claim:

1. A method, comprising:
obtaining, by at least one server computer, content information for a product list, the content information comprising one or more common data elements for a plurality of platforms;
obtaining, by the at least one server computer, a template for configuring the content information for display with a unified layout on a plurality of the platforms; and
inserting, by the at least one server computer, the content information into the template.

2. The method of claim 1, wherein obtaining the content information comprises receiving a digitized copy of a paper version of the product list.

3. The method of claim 1, wherein obtaining the content information comprises scraping a previous website containing the product list.

4. The method of claim 1, wherein obtaining the template comprises receiving, from a user, a selection of the template from a plurality of template selections.

5. The method of claim 1, wherein inserting the content information into the template comprises:
identifying, within the template, a plurality of template tags indicating locations within the template where structured data can be inserted;
extracting the structured data from the content information; and
inserting the structured data into the template at the locations of the template tags.

6. The method of claim 1, wherein inserting the content information into the template comprises:
parsing the content information into a plurality of content elements; and
columnating one or more of the content elements.

7. The method of claim 6, wherein columnating one or more of the content elements comprises:
determining a number of columns to display on a page;
estimating a column height for each of the columns;
until all content elements to be columnated are added to one of the columns, for each column:
adding one of the content elements to the column;
checking for an overflow of content beyond the column height;
returning to the adding step if there is no overflow; and
continuing to another column if there is an overflow.

8. The method of claim 7, wherein columnating one or more of the content elements further comprises rebalancing the content elements across the columns.

9. The method of claim 6, wherein inserting the content information into the template further comprises paginating one or more of the content elements.

10. The method of claim 9, wherein paginating one or more of the content elements comprises:
identifying a target element containing the content element;
copying the target element to a new page; and
adding the content element to the new page.

11. The method of claim 1, wherein the template comprises a markup component, a style component, and an image component.

12. The method of claim 11, wherein the markup component comprises a plurality of editables.

13. The method of claim 1, wherein the plurality of platforms includes a website, a social networking page, a mobile website, and printed paper.

14. The method of claim 13, wherein inserting the content information into the template comprises typesetting the product list.

15. A system, comprising at least one server computer in electronic communication with a computer network and configured to:
obtain content information for a product list, the content information comprising one or more common data elements for a plurality of platforms;
obtain a template for configuring the content information for display with a unified layout on a plurality of the platforms; and
insert the content information into the template such that the content information is typeset in a substantially similar layout.

16. The system of claim 15, wherein the at least one server computer is further configured to display, to a user, a user interface for editing a display of the product list on one or more of the platforms, wherein:
the template is generated by a template language and comprises one or more editables, each editable being configured to receive input from the user without presenting the template language to the user.

17. The system of claim 15, wherein the plurality of platforms includes a website, a social networking page, a mobile website, and printed paper.

18. The system of claim 15, wherein the at least one server computer is configured to insert the content information into the template by:
identifying, within the template, a plurality of template tags indicating locations within the template where structured data can be inserted;
extracting the structured data from the content information; and
inserting the structured data into the template at the locations of the template tags.

19. The system of claim 18, wherein the at least one server computer is further configured to insert the content information into the template by:
parsing the content information into a plurality of content elements; and
columnating one or more of the content elements.

20. The system of claim 19, wherein columnating one or more of the content elements comprises:
determining a number of columns to display on a page;
estimating a column height for each of the columns;
until all content elements to be columnated are added to one of the columns, for each column:
adding one of the content elements to the column;
checking for an overflow of content beyond the column height;
returning to the adding step if there is no overflow; and
continuing to another column if there is an overflow; and
rebalancing the content elements across the columns.
